(19) United States
(12) Patent Application Publication
(10) Pub. No.: US 2025/0149734 A1
(43) Pub. Date: May 8, 2025

(54) RECHARGEABLE LITHIUM BATTERY

(71) Applicant: SAMSUNG SDI CO. LTD., Yongin-si (KR)

(72) Inventors: MINJEONG LEE, Yongin-si (KR); Changhong Ko, Yongin-si (KR); Sam-Jin Park, Yongin-si (KR); Jinweon Seo, Yongin-si (KR)

(21) Appl. No.: 18/739,471

(22) Filed: Jun. 11, 2024

(30) Foreign Application Priority Data
Nov. 8, 2023 (KR) 10-2023-0154003

(51) Int. Cl. H01M 50/446; H01M 10/052; H01M 10/0587; H01M 50/42; H01M 50/434; H01M 50/457; H01M 50/489

(52) U.S. Cl. CPC H01M 50/446; H01M 10/052; H01M 10/0587; H01M 50/42; H01M 50/434; H01M 50/457; H01M 50/489

(57) ABSTRACT

A rechargeable lithium battery includes a positive electrode including a positive electrode active material having a nickel content among a transition metal of greater than or equal to about 90 mol %; a negative electrode; and a separator between the positive electrode and the negative electrode, wherein the separator includes a substrate; a heat resistant adhesive layer on one surface of the substrate; and a heat resistant layer on the other surface of the substrate, the heat resistant adhesive layer includes first inorganic particles; and a swellable adhesive binder, the swellable adhesive binder includes a first structural unit of a vinyl aromatic monomer; a second structural unit of an alkyl acrylate monomer; and a third structural unit of a phosphonate monomer, the heat resistant layer includes second inorganic particles; and a heat resistant binder.

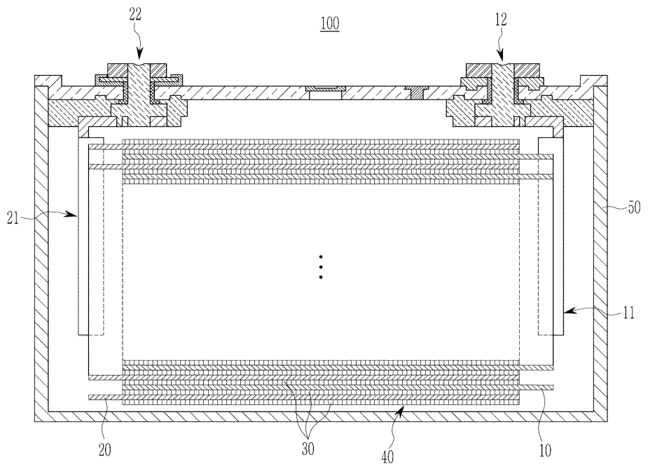

### CROSS-REFERENCE TO RELATED APPLICATION

This application claims priority to and the benefit of Korean Patent Application No. 10-2023-0154003 filed in the Korean Intellectual Property Office on Nov. 8, 2023, the entire contents of which are incorporated herein by reference.

### BACKGROUND

### 1. Field

Embodiments relate to a rechargeable lithium battery.

### 2. Description of the Related Art

Recently, with the rapid spread of electronic devices that use batteries, e.g., mobile phones, laptop computers, and electric vehicles, the demand for rechargeable batteries with high energy density and high capacity is rapidly increasing. Accordingly, research and development to improve the performance of rechargeable lithium batteries is actively underway.

A rechargeable lithium battery may include a positive electrode and a negative electrode including an active material capable of intercalating and deintercalating lithium ions, and an electrolyte solution, and electrical energy may be produced through oxidation and reduction reactions when lithium ions are intercalated/deintercalated from the positive electrode and negative electrode.

### SUMMARY

The embodiments may be realized by providing a rechargeable lithium battery including a positive electrode including a positive electrode active material having a nickel content among a transition metal of greater than or equal to about 90 mol %; a negative electrode; and a separator between the positive electrode and the negative electrode, wherein the separator includes a substrate; a heat resistant adhesive layer on one surface of the substrate; and a heat resistant layer on another surface of the substrate, the heat resistant adhesive layer includes first inorganic particles; and a swellable adhesive binder, the swellable adhesive binder includes a first structural unit of a vinyl aromatic monomer; a second structural unit of an alkyl acrylate monomer; and a third structural unit of a phosphonate monomer, the heat resistant layer includes second inorganic particles; and a heat resistant binder.

In the swellable adhesive binder, the first structural unit of the vinyl aromatic monomer may be represented by Chemical Formula 1, the second structural unit of the alkyl acrylate monomer may be represented by Chemical Formula 2, and the third structural unit of the phosphonate monomer may be represented by Chemical Formula 3:

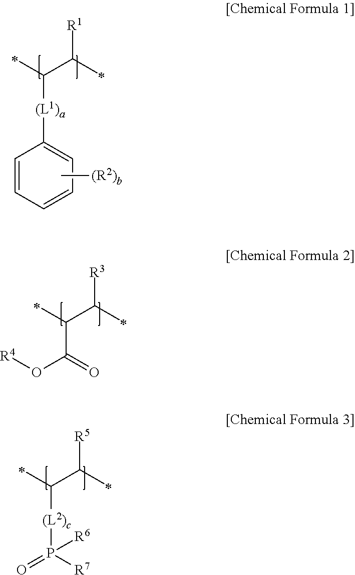

in Chemical Formulae 1 to 3, R¹, R³, and R⁵ may be each independently hydrogen or a substituted or unsubstituted C1 to C6 alkyl group; R² may be fluorine, a substituted or unsubstituted C1 to C6 alkyl group, a substituted or unsubstituted C6 to C20 aryl group, or a substituted or unsubstituted C1 to C6 alkenyl group, R⁴ may be a substituted or unsubstituted C1 to C20 alkyl group, L¹ may be a substituted or unsubstituted C1 to C6 alkylene group, a substituted or unsubstituted C3 to C10 cycloalkylene group, a substituted or unsubstituted C6 to C20 arylene group, or a combination thereof, L² may be a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof, R⁶ and R⁷ may be each independently a substituted or unsubstituted C1 to C10 alkoxy group, or a substituted or unsubstituted C6 to C20 aryloxy group, a and c may be each independently an integer of 0 to 2, and b may be an integer of 0 to 5.

The swellable adhesive binder may be a particle with a core-shell structure, and the shell may include the first structural unit of a vinyl aromatic monomer; the second structural unit of an alkyl acrylate monomer; and the third structural unit of a phosphonate monomer.

The first inorganic particles may include Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

A weight ratio of the swellable adhesive binder and the first inorganic particles in the heat resistant adhesive layer may be about 1:3 to about 1:20.

The heat resistant adhesive layer may have a thickness of about 0.1 μm to about 5 μm.

The heat resistant binder may include a first heat resistant binder, a second heat resistant binder, or a combination thereof, the first heat resistant binder may include a fourth structural unit of a (meth)acrylic acid monomer or a (meth)acrylate monomer; a cyano group-containing fifth structural unit; and a sulfonate group-containing sixth structural unit, and the second heat resistant binder may include a seventh structural unit including a structural unit of a (meth)acrylic acid monomer or a (meth)acrylate monomer and a structural unit of a (meth)acrylamide monomer; and an eighth structural unit of a (meth)acrylamidosulfonic acid monomer or a salt thereof.

The fourth structural unit of a (meth)acrylic acid monomer or a (meth)acrylate monomer may be represented by of Chemical Formula 11, Chemical Formula 12, Chemical Formula 13, of a combination thereof, the cyano group-containing fifth structural unit may be represented by Chemical Formula 14, and the sulfonate group-containing sixth structural unit may be represented by Chemical Formula 15, Chemical Formula 16, Chemical Formula 17, or a combination thereof:

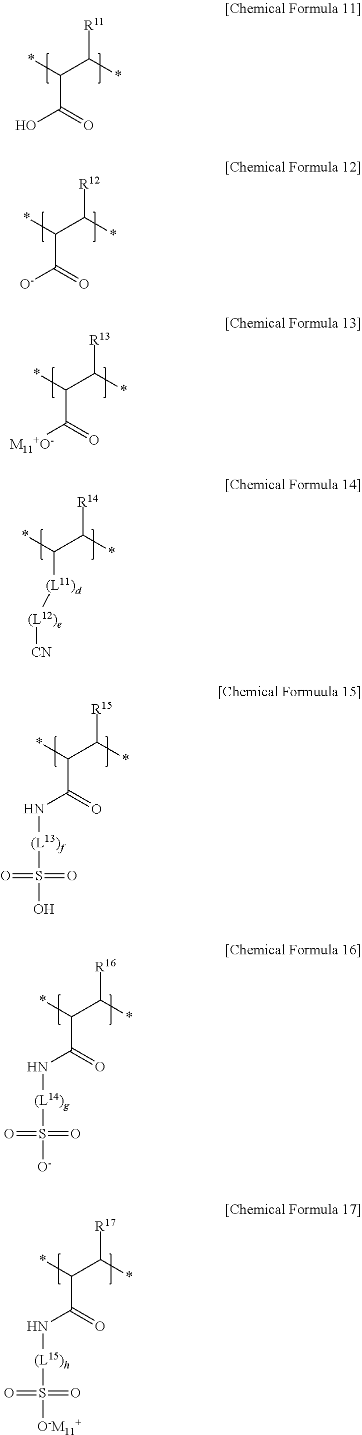

in Chemical Formulae 11 to 17, R¹¹ to R¹⁷ may be each independently hydrogen or a substituted or unsubstituted C1 to C6 alkyl group; L¹¹ and L¹² may be each independently a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; L¹³ to L¹⁵ may be each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; M₁₁ may be an alkali metal; and d, e, f, g, and h may be each independently an integer of 0 to 2.

The seventh structural unit including the structural unit of a (meth)acrylic acid monomer or a (meth)acrylate monomer may be represented by Chemical Formula 101, Chemical Formula 102, Chemical Formula 103, or a combination thereof, the seventh structural unit including the structural unit of a (meth)acrylamide monomer may be represented by Chemical Formula 104, and the eighth structural unit of a (meth)acrylamidosulfonic acid monomer or a salt thereof may be represented by Chemical Formula 105, Chemical Formula 106, Chemical Formula 107, or a combination thereof:

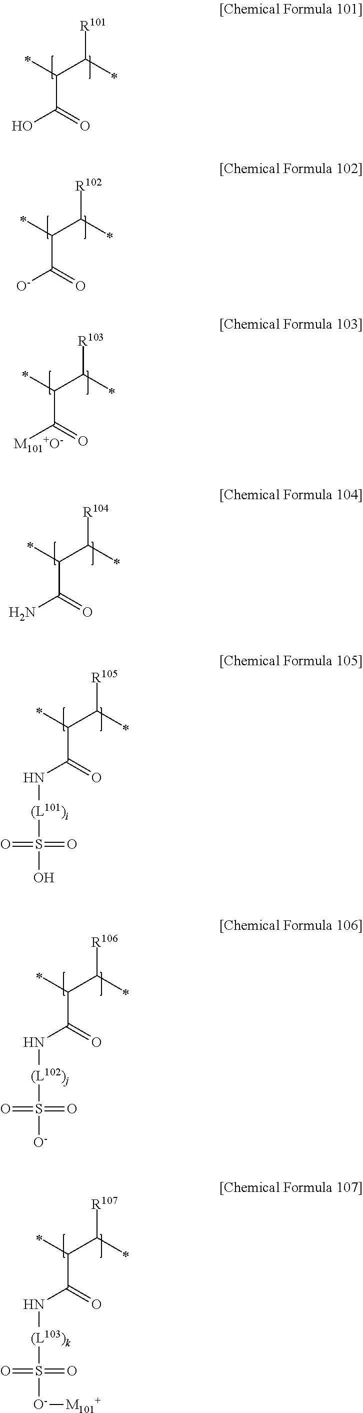

in Chemical Formulae 101 to 107, R¹⁰¹ to R¹⁰⁷ may be each independently hydrogen or a substituted or unsubstituted C1 to C6 alkyl group; L¹⁰¹ to L¹⁰³ may be each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group; M₁₀₁ may be an alkali metal; and i, j, and k may be each independently an integer of 0 to 2.

The second inorganic particles may include Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

A weight ratio of the heat resistant binder and the second inorganic particles in the heat resistant layer may be about 1:2 to about 1:50.

The heat resistant layer may have a thickness of about 0.1 μm to about 5 μm.

The substrate may be a polyolefin substrate.

The substrate may have a thickness of about 1 μm to about 40 μm.

The heat resistant adhesive layer may be attached to the negative electrode, and the heat resistant layer may be attached to the positive electrode.

The positive electrode may include a positive electrode active material represented by Chemical Formula I:

Liₐ₁Niₓ₁M¹_{y1}M²_{z1}O_{2-b1}X_{b1} [Chemical Formula I]

in Chemical Formula I, 0.9≤a1≤1.8, 0.9≤x1≤1, 0≤y1≤0.1, 0≤z1≤0.1, 0.9≤x1+y1+z1≤1.1, and 0≤b1≤0.1, M¹ and M² may be each independently Al, B, Ba, Ca, Ce, Co, Cr, Cu, Fe, Mg, Mn, Mo, Nb, Si, Sn, Sr, Ti, V, W, or Zr, and X may be F, P, or S.

The negative electrode may include negative electrode active material including a carbon negative electrode active material, a Si negative electrode active material, or a combination thereof.

The rechargeable lithium battery may further include an electrolyte solution impregnated in the separator.

The electrolyte solution may include a lithium salt and a non-aqueous organic solvent.

The rechargeable lithium battery has an energy density of greater than or equal to about 700 Wh/L.

### BRIEF DESCRIPTION OF THE DRAWING

Features will become apparent to those of skill in the art by describing in detail exemplary embodiments with reference to the attached drawing in which:

the FIGURE is a sectional view of a rechargeable lithium battery according to some embodiments.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing FIGURE, the dimensions of layers and regions may be exaggerated for clarity of illustration. addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, it will be understood that when an element such as a layer, film, region, or substrate is referred to as being “on” another element, it can be directly on the other element or intervening elements may also be present.

As used herein, when specific definition is not otherwise provided, the singular may also include the plural. In addition, unless otherwise specified, “A or B” is not an exclusive term, and may mean “including A, including B, or including A and B.”

As used herein, “combination thereof” may mean a mixture, a stack, a composite, a copolymer, an alloy, a blend, or a reaction product of constituents.

As used herein, when a definition is not otherwise provided, a particle diameter may be an average particle diameter. This average particle diameter means an average particle diameter (D50), which is a diameter of particles with a cumulative volume of 50 volume % in the particle size distribution. The average particle diameter (D50) can be measured by methods well known to those skilled in the art, for example, by measuring with a particle size analyzer, a transmission electron microscope or scanning electron microscope, or a scanning electron microscope. Alternatively, a dynamic light-scattering measurement device is used to perform a data analysis, and the number of particles is counted for each particle size range. From this, the average particle diameter (D50) value may be easily obtained through a calculation. A laser diffraction method may also be used. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle diameter (D50) based on 50% of the particle size distribution in the measuring device can be calculated.

As used herein, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C7 to C20 arylalkyl group, “alkylene group” refers to a C1 to C20 alkylene group, “arylene group” refers to a C6 to C20 arylene group, “alkylarylene group” refers to a C7 to C20 alkylarylene group, “heteroarylene group” refers to a C3 to C20 heteroarylene group, and “alkoxylene group” refers to a C1 to C20 alkoxylene group.

As used herein, when specific definition is not otherwise provided, “substituted” refers to replacement of at least one hydrogen by a substituent of a halogen atom (F, Cl, Br, I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, C6 to C20 aryl group, C3 to C20 cycloalkyl group, C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when specific definition is not otherwise provided, “hetero” refers to inclusion of at least one heteroatom of N, O, S, and P in chemical formulas.

As used herein, when specific definition is not otherwise provided, “(meth)acrylate” refers to both “acrylate” and “methacrylate,” and “(meth)acrylic acid” refers to “acrylic acid” and “methacrylic acid”.

In chemical formulas of the present specification, unless a specific definition is otherwise provided, hydrogen is bonded at the position when a chemical bond is not drawn where supposed to be given.

As used herein, a weight average molecular weight (Mw) may be a value measured using gel permeation chromatography (GPC).

### (Rechargeable Lithium Battery)

In order to increase the capacity or output of a rechargeable lithium battery, a positive electrode active material (e.g., a high nickel positive electrode active material having a nickel content of greater than or equal to about 90 mol % among the transition metals) may be used. The rechargeable lithium battery may have an energy density of greater than or equal to about 700 Wh/L.

As the rechargeable lithium battery increases in capacity or output, the amount of heat generated during charging and discharging may increase, and thus the heat resistance of the separator may need to be strengthened.

The adhesive strength between the separator and the negative electrode could be weakened, compared to the adhesive strength between the separator and the positive electrode, e.g., due to the gas generated when storing or charging and discharging the rechargeable lithium battery at a high temperature. This tendency could be intensified when using a positive electrode active material with a nickel content of greater than or equal to about 90 mol % among the transition metals. As a result, lithium salt could precipitate faster between the separator and the negative electrode than between the separator and the positive electrode, and the efficiency of the rechargeable lithium battery could decrease and the resistance may increase. Accordingly, the adhesive strength between the separator and the negative electrode may need to be strengthened.

In this regard, some embodiments may provide a rechargeable lithium battery including a positive electrode including a positive electrode active material having a nickel content among a transition metal of greater than or equal to about 90 mol %; a negative electrode; and a separator between the positive electrode and the negative electrode. In an implementation, the separator may include a substrate; a heat resistant adhesive layer on one surface of the substrate; and a heat resistant layer on the other surface of the substrate. In an implementation, the heat resistant adhesive layer may include first inorganic particles; and a swellable adhesive binder. In an implementation, the swellable adhesive binder may include a first structural unit of a vinyl aromatic monomer; a second structural unit of an alkyl acrylate monomer; and a third structural unit of a phosphonate monomer. In an implementation, the heat resistant layer may include second inorganic particles; and a heat resistant binder.

The separator may have excellent heat resistance on both sides and enhanced adhesive strength on one side. In an implementation, the one side with enhanced adhesive strength may be the heat resistant adhesive layer, and the heat resistant adhesive layer may be attached to the negative electrode to help strengthen the adhesive strength between the separator and the negative electrode. As a result, the high-temperature charging/discharging or storage characteristics of high-capacity or high-output rechargeable lithium batteries may be improved. In an implementation, the heat resistant layer may be attached to the positive electrode.

Hereinafter, a rechargeable lithium battery according to some embodiments will be described in more detail.

### Physical Properties of Separator

The separator may include the heat resistant adhesive layer, and a wet adhesive strength between the separator and the negative electrode of greater than or equal to about 0.05 gf/mm may be secured after going through a process under low-temperature and low-pressure conditions.

In an implementation, the separator may include the heat resistant layer, the dry shrinkage rate at 150° C. may be within 5%, the wet adhesive strength may be secured at least 0.1 gf/mm after going through a process under low-temperature and low-pressure conditions, and the wet shrinkage rate may be satisfied within 15%.

A separator having the above physical properties may help improve the high-temperature charging/discharging or storage characteristics of a rechargeable lithium battery.

### Heat Resistant Adhesive Layer

The heat resistant adhesive layer may include a swellable adhesive binder and first inorganic particles. In an implementation, the swellable adhesive binder may be a binder excellent in both heat resistance and adhesive strength, and the heat resistant adhesive layer may harmoniously and simultaneously exhibit heat resistance and adhesive strength as a single layer.

Within the heat resistant adhesive layer, the swellable adhesive binder may be relatively distributed in or at an upper portion, and the first inorganic particles may be relatively distributed in or at a lower portion. These may be caused by the D50 particle size of the swellable adhesive binder, a difference in density between the swellable adhesive binder and the first inorganic particle, or the like.

However, the relative distribution of the swellable adhesive binder and the first inorganic particles within the heat resistant adhesive layer may be different, and complete phase separation may not occur. Accordingly, it may be structurally different from the coating layer formed in a multi-layer structure of two or more layers.

### Swellable Adhesive Binder

Some binders may only exhibit wet adhesive strength under high-temperature and high-pressure conditions.

Prismatic rechargeable lithium batteries may be manufactured by inserting a jelly roll (in which a stack of positive electrode/separator/negative electrode is wound) into a prismatic can and then injecting an electrolyte solution. High-temperature and high-pressure conditions may not be applied during or after the manufacturing process. If some binders were to be applied to prismatic rechargeable lithium batteries, wet adhesive strength may not be secured.

This phenomenon could be accelerated in the case of applying a high nickel positive electrode active material to a rechargeable lithium battery to achieve high capacity/high power.

In an implementation, the swellable adhesive binder may include a first structural unit of a vinyl aromatic monomer; a second structural unit of an alkyl acrylate monomer; and a third structural unit of a phosphonate monomer, and wet adhesive strength may be achieved even under low-temperature and low-pressure conditions.

Accordingly, the separator according to some embodiments may help secure wet adhesive strength even under low-temperature and low-pressure conditions during the manufacturing process (e.g., formation process) of a prismatic rechargeable lithium battery.

In an implementation, the first structural unit of the vinyl aromatic monomer may be represented by Chemical Formula 1.

In an implementation, the second structural unit of the alkyl acrylate monomer may be represented by Chemical Formula 2.

In an implementation, the third structural unit of the phosphonate monomer may be represented by Chemical Formula 3.

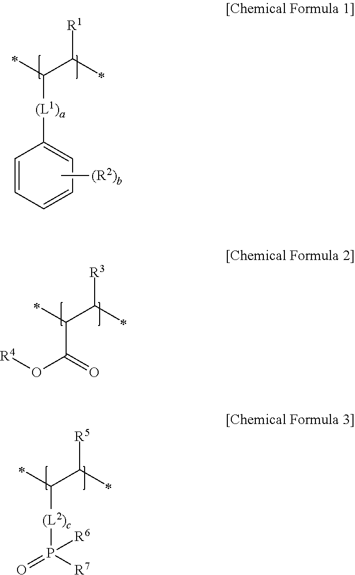

The descriptions of Chemical Formulae 1 to 3 are as follows:
R¹, R³, and R⁵ may each independently be or include, e.g., hydrogen or a substituted or unsubstituted C1 to C6 alkyl group. In an implementation, R¹ may be hydrogen, R³ may be a substituted or unsubstituted methyl group, and R⁵ may be hydrogen or a substituted or unsubstituted methyl group.
R² may be or may include, e.g., fluorine, a substituted or unsubstituted C1 to C6 alkyl group, a substituted or unsubstituted C6 to C20 aryl group, or a substituted or unsubstituted C1 to C6 alkenyl group.
R⁴ may be or may include, e.g., a substituted or unsubstituted C1 to C20 alkyl group. In an implementation, R⁴ may be, e.g., a 2-ethylhexyl group.
L¹ may be or may include, e.g., a substituted or unsubstituted C1 to C6 alkylene group, a substituted or unsubstituted C3 to C10 cycloalkylene group, a substituted or unsubstituted C6 to C20 arylene group, or a combination thereof.
L² may be or may include, e.g., a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof. In an implementation, L² may be, e.g., a carboxyl group (—C(═O)O—).
R⁶ and R⁷ may each independently be or include, e.g., a substituted or unsubstituted C1 to C10 alkoxy group, or a substituted or unsubstituted C6 to C20 aryloxy group. In an implementation, R⁶ and R⁷ may both be, e.g., substituted or unsubstituted methoxy groups.
a and c may each independently be, e.g., an integer of 0 to 2. b may be, e.g., an integer of 0 to 5. In an implementation, a may be 0, b may be 0, and c may be 1.

The swellable adhesive binder may be in the form of particles and may maintain the particle form without dissolving in an aqueous solvent.

In an implementation, the swellable adhesive binder may be particles having a core-shell structure, and it may be desirable to secure an appropriate average particle size and swelling rate. Components of the core may include, e.g., an acrylic polymer, a diene polymer, or a copolymer thereof. The shell may include, e.g., the first structural unit of a vinyl aromatic monomer; the second structural unit of an alkyl acrylate monomer; and the third structural unit of a phosphonate monomer.

Based on a total weight of the shell of the swellable adhesive binder, the first structural unit may be included in an amount of greater than or equal to about 40 wt % and less than or equal to about 90 wt %, or greater than or equal to about 50 wt % and less than or equal to about 80 wt %; the second structural unit may be included in an amount of about 5 wt % to about 40 wt %, or about 10 wt % to about 30 wt %; and the third structural unit may be included in an amount of about 0.1 wt % to about 20 wt %, or about 5 wt % to about 20 wt %.

In an implementation, a D50 particle size of the swellable adhesive binder may be about 0.1 μm to about 1 μm, about 0.2 μm to about 0.9 μm, about 0.2 μm to about 0.8 μm, or about 0.2 μm to about 0.7 μm. Within these ranges, the heat resistant adhesive layer may achieve excellent adhesive strength even at a thin thickness without deteriorating the heat resistance of the separator.

A glass transition temperature of the swellable adhesive binder may be about 60° C. to about 120° C., about 60° C. to about 90° C., or about 60° C. to about 75° C. Within these ranges, the swellable adhesive binder may exhibit wet adhesive strength even under low-temperature and low-pressure conditions, and the heat resistant adhesive layer may realize excellent adhesive strength even at a thin thickness without deteriorating the heat resistance of the separator.

After being left in an electrolyte solution at 60° C. for 72 hours, the swellable adhesive binder may expand about 2 to about 1,000 times, about 3 to about 1,000 times, or about 6 to about 1,000 times its initial volume. Within these ranges, the swellable adhesive binder may exhibit wet adhesive strength even under low-temperature and low-pressure conditions, and the heat resistant adhesive layer may realize excellent adhesive strength even with a small thickness without reducing the heat resistance and air permeability of the separator.

The electrolyte solution composition may follow the examples, described below.

A weight average molecular weight of the swellable adhesive binder may be about 100,000 g/mol to about 800,000 g/mol, or about 300,000 g/mol to about 500,000 g/mol as measured by GPC method.

In the heat resistant adhesive layer, a loading amount of the swellable adhesive binder may be about 0.05 to about 1 g/m².

### First Inorganic Particles

The first inorganic particles may help reduce the possibility of a short circuit between the positive electrode and the negative electrode and may help prevent the separator from rapidly shrinking or deforming due to temperature increase. In an implementation, the heat resistant adhesive layer may help improve the heat resistance and safety of the battery by including the first inorganic particles.

The first inorganic particles may include, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

In an implementation, the first inorganic particle may include boehmite, which may facilitate control the D50 particle size and shape.

The D50 particle size of the first inorganic particle may be, e.g., about 0.1 μm to about 10 μm, about 0.1 μm to about 5 μm, or about 0.1 μm to about 1 μm.

In an implementation, the first inorganic particle may be plate-shaped or fibrous, and an aspect ratio of the inorganic particle may be about 1:5 to about 1:100, e.g., about 1:10 to about 1:100, about 1:5 to about 1:50, or about 1:10 to about 1:50. In an implementation, a ratio of the length of the major axis to the minor axis on the flat surface of the plate-shaped inorganic particle may be about 1 to 3 or about 1 to 2. The aspect ratio and the ratio of the length of the major axis to the minor axis may be measured using an optical microscope. Maintaining the aspect ratio and the length ranges of the minor axis to the major axis as described above may help ensure that a heat shrinkage rate of the separator may be lowered, relatively improved porosity may be secured, and the physical stability of the lithium battery may be improved.

### Composition of Heat Resistant Adhesive Layer

A weight ratio of the swellable adhesive binder and the first inorganic particles in the heat resistant adhesive layer may be, e.g., about 1:3 to about 1:20, about 1:5 to about 1:15, or about 1:8 to about 1:11.

### Thickness of Heat Resistant Adhesive Layer

The thickness of the heat resistant adhesive layer may be, e.g., 5 length % to 45 length %, or 10 length % to 30 length % of the thickness of the substrate, based on the thickness of the heat resistant adhesive layer formed on one surface of the porous substrate.

In an implementation, a thickness of the heat resistant adhesive layer may be about 0.1 μm to about 5 μm, or about 0.1 μm to about 3 μm.

### Heat Resistant Layer

The heat resistant layer may include a heat resistant binder and second inorganic particles. The heat resistant binder may be a binder with excellent heat resistance, and the heat resistant layer may exhibit excellent heat resistance as a single layer.

### Heat Resistant Binder

The heat resistant binder may include, e.g., a first heat resistant binder, a second heat resistant binder, or a combination thereof.

The first heat resistant binder may include a fourth structural unit of a (meth)acrylic acid monomer or a (meth)acrylate monomer; a cyano group-containing fifth structural unit; and a sulfonate group-containing sixth structural unit.

The fourth structural unit of a (meth)acrylic acid monomer or a (meth)acrylate monomer may be represented by, e.g., Chemical Formula 11, Chemical Formula 12, Chemical Formula 13, or a combination thereof.

The cyano group-containing fifth structural unit may be represented by, e.g., Chemical Formula 14.

The sulfonate group-containing sixth structural unit may be represented by, e.g., Chemical Formula 15, Chemical Formula 16, Chemical Formula 17, or a combination thereof.

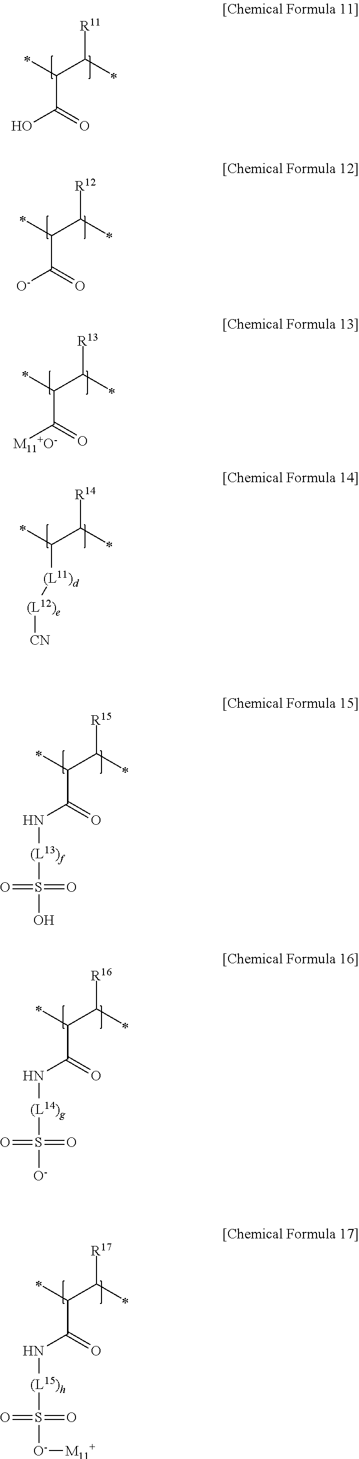

The descriptions of Chemical Formulas 11 to 17 are as follows.

R¹¹ to R¹⁷ may each independently be or include, e.g., hydrogen or a substituted or unsubstituted C1 to C6 alkyl group. In an implementation, R¹¹ to R¹⁷ may all be hydrogen.

L¹¹ and L¹² may each independently be or include, e.g., a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. In an implementation, L¹¹ and L¹² may all be a single bond.

L¹³ to L¹⁵ may each independently be or include, e.g., a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. In an implementation, L¹³ to L¹⁵ may all be *—C(CH₃)₂—CH₂—*.

M₁₁ may be an alkali metal. The alkali metal may be, e.g., lithium, sodium, potassium, rubidium, or cesium. In an implementation, the alkali metal may be lithium or sodium.

d, e, f, g, and h may each independently be an integer 0 to 2. In an implementation, d, e, f, g, and h may all be 1.

The fourth structural unit of a (meth)acrylic acid monomer or a (meth)acrylate monomer may include, respectively or together, the structural unit represented by Chemical Formula 11 and the structural unit represented by Chemical Formula 13. In the latter case, the structural unit of a (meth)acrylic acid monomer or a (meth)acrylate monomer may include the structural unit represented by Chemical Formula 11 and the structural unit represented by Chemical Formula 13 in a molar ratio of about 1:10 to about 2:1, about 1:5 to about 1:1, or about 1:3 to about 1:1.

The sulfonate group-containing sixth structural unit may include, respectively or together, the structural unit represented by Chemical Formula 15 and the structural unit represented by Chemical Formula 17. In the latter case, the sulfonate group-containing sixth structural unit may include the structural unit represented by Chemical Formula 15 and a structural unit represented by Chemical Formula 17 in a molar ratio of about 1:10 to about 2:1, about 1:5 to about 1:1, or about 1:3 to about 1:1.

Based on 100 mol % of the first heat resistant binder, the fourth structural unit may be included in an amount of greater than or equal to about 10 mol % to less than or equal to about 70 mol %, greater than or equal to about 30 mol % to less than or equal to about 60 mol %, or greater than or equal to about 40 mol % to less than or equal to about 50 mol %; the fifth structural unit may be included in an amount of greater than or equal to about 30 mol % to less than or equal to about 85 mol %, greater than or equal to about 40 mol % to less than or equal to about 70 mol %, or greater than or equal to about 45 mol % to less than or equal to about 55 mol %; and the sixth structural unit may be included in an amount of greater than or equal to about 0.1 mol % to less than or equal to about 20 mol %, greater than or equal to about 0.5 mol % to less than or equal to about 15 mol %, or greater than or equal to about 1 mol % to less than or equal to about 10 mol %.

In an implementation, the heat resistant binder may include a compound including the structural units of Chemical Formula 18.

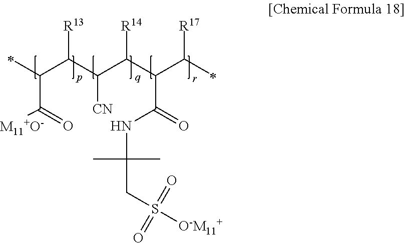

R¹³, R¹⁴, and R¹⁷ may each independently be, e.g., hydrogen or a substituted or unsubstituted C1 to C6 alkyl group. In an implementation, R¹³, R¹⁴, and R¹⁷ may all be hydrogen.
M₁ may be alkali metal. The alkali metal may be lithium, sodium, potassium, rubidium, or cesium, e.g., lithium or sodium.

The p, q, and r mean a molar ratio of each unit, and may be 0.1≤p≤0.7, 0.3≤m≤0.85, and 0.001≤n≤0.2. In an implementation, they may be 0.3≤p≤0.6, 0.4≤q≤0.7, and 0.005≤r≤0.15. In an implementation, they may be 0.4≤p≤0.5, 0.45≤q≤0.55, and 0.01≤r≤0.1.

The first heat resistant binder represented by the Chemical Formula 18 may be, e.g., poly(acrylic acid-co-acrylonitrile-co-lithium 2-acrylamido-2-methylpropanesulfonate salt).

The first heat resistant binder may be prepared by various suitable methods such as emulsion polymerization, suspension polymerization, massive polymerization, solution polymerization, or bulk polymerization.

The first adhesive binder may have a weight average molecular weight (Mw) of about 200,000 to about 7,000,000 g/mol as measured by GPC method.

The second heat resistant binder may include a seventh structural unit including a structural unit of a (meth)acrylic acid monomer or a (meth)acrylate monomer and a structural unit of a (meth)acrylamide monomer; and an eighth structural unit of a (meth)acrylamidosulfonic acid monomer or a salt thereof.

The structural unit of the a (meth)acrylic acid monomer or (meth)acrylate monomer may be represented by Chemical Formula 101, Chemical Formula 102, Chemical Formula 103, or a combination thereof.

The structural unit of the (meth)acrylamide monomer may be represented by Chemical Formula 104.

The eighth structural unit of the (meth)acrylamidosulfonic acid monomer or the salt thereof may be represented by Chemical Formula 105, Chemical Formula 106, Chemical Formula 107, or a combination thereof.

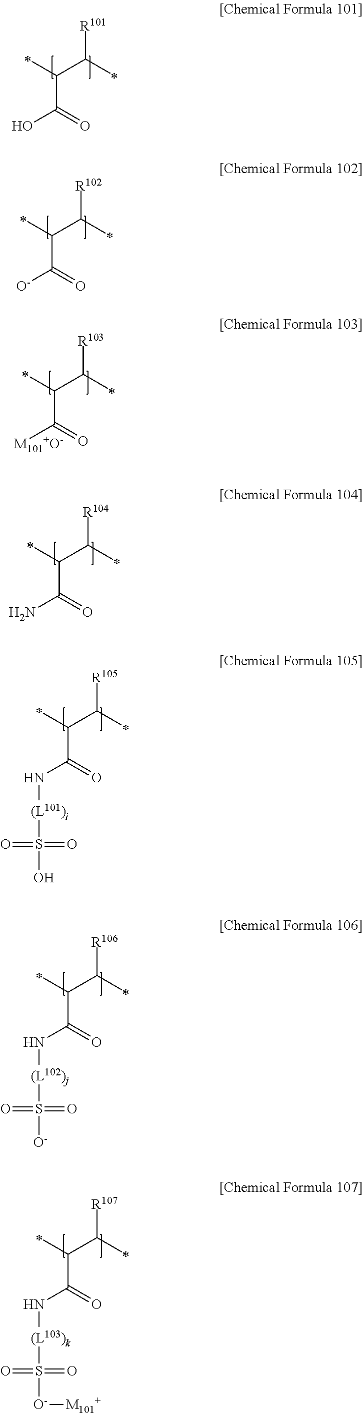

The descriptions of Chemical Formulas 101 to 107 are as follows:
R¹⁰¹ to R¹⁰⁷ may each independently be, e.g., hydrogen or a substituted or unsubstituted C1 to C6 alkyl group. In an implementation, R¹⁰¹ to R¹⁰⁷ may all be hydrogen.
L¹⁰¹ to L¹⁰³ may each independently be, e.g., a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group. In an implementation, L¹⁰¹ to L¹⁰³ may all be *—C(CH₃)₂—CH₂—*.
M₁₀₁ may be an alkali metal. The alkali metal may be lithium, sodium, potassium, rubidium, or cesium, e.g. lithium or sodium.
i, j, and k may each independently be an integer of 0 to 2. In an implementation, i, j, and k may all be 1.

The structural unit of a (meth)acrylic acid monomer or a (meth)acrylate monomer may include, respectively, or together, the structural unit represented by Chemical Formula 101 and the structural unit represented by Chemical Formula 103. In the latter case, the structural unit derived from the (meth)acrylic acid or (meth)acrylate may include the structural unit represented by Chemical Formula 101 and the structural unit represented by Chemical Formula 103 in a molar ratio of about 1:10 to about 2:1, about 1:5 to about 1:1, or about 1:3 to about 1:1.

The eighth structural unit of the (meth)acrylamidosulfonic acid monomer or the salt thereof may include respectively, or together, the structural unit represented by Chemical Formula 105 and the structural unit represented by Chemical Formula 107. In the latter case, the structural unit derived from (meth)acrylamidosulfonic acid or the salt thereof may include the structural unit represented by Chemical Formula 105 and the structural unit represented by Chemical Formula 107 in a molar ratio of about 1:10 to about 2:1, about 1:5 to about 1:1, or about 1:3 to about 1:1.

Based on 100 mol % of the second heat resistant binder, the seventh structural unit may be included in an amount of greater than or equal to about 90 mol % and less than about 100 mol %; and the eighth structural unit may be included in an amount of greater than about 0 mol % and less than or equal to about 10 mol %.

In an implementation, the second heat resistant binder may include a compound including structural units of Chemical Formula 108.

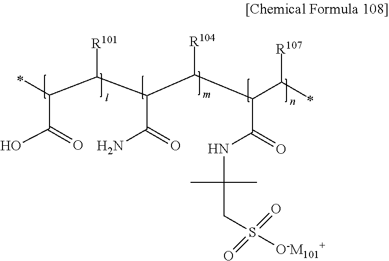

R¹⁰¹, R¹⁰⁴, and R¹⁰⁷ may each independently be, e.g., hydrogen or a substituted or unsubstituted C1 to C6 alkyl group. In an implementation, R¹⁰¹, R¹⁰⁴, and R¹⁰⁷ may all be hydrogen.
M₁₀₁ may be an alkali metal. The alkali metal may be lithium, sodium, potassium, rubidium, or cesium, e.g. lithium or sodium.
l, m, and n mean a molar ratio of each unit, 0.9≤(l+m)<1, and 0<n≤0.1, and l+m+n=1. In an implementation, they may be 0≤l≤0.4, 0.55≤m≤0.95, and 0<n≤0.1. In an implementation, they may be 0≤l≤0.2, 0.8≤m≤0.95, and 0<n≤0.1.

The second heat resistant binder represented by Chemical Formula 108 may be, e.g., poly(acrylic acid-co-acrylamide-co-lithium 2-acrylamido-2-methylpropanesulfonate salt).

The second heat resistant binder may be prepared by various suitable methods such as emulsion polymerization, suspension polymerization, bulk polymerization, solution polymerization, or bulk polymerization.

The second heat resistant binder may have a weight average molecular weight of about 350,000 g/mol to about 970,000 g/mol as measured by GPC method.

### Second Inorganic Particles

Like the first inorganic particles, the second inorganic particles may help reduce the possibility of a short circuit between the positive electrode and the negative electrode and prevent the separator from rapidly shrinking or deforming due to a rise in temperature. In an implementation, the heat resistance layer may help improve the heat resistance and safety of the battery by including second inorganic particles.

The descriptions of the second inorganic particles may be the same as the description of the first inorganic particles.

### Composition of Heat Resistant Layer

A weight ratio of the heat resistant binder and the second inorganic particles in the heat resistant layer may be about 1:2 to about 1:50, about 1:3 to about 1:45, about 1:10 to about 1:40, or about 1:15 to about 1:35.

The heat resistant binder may include only one of the first heat resistant binder and the second heat resistant binder, or both.

In the latter case, it may be included in a weight ratio of about 1:9 to about 9:1, about 7:3 to about 3:7, or about 4:6 to about 6:4. Within these ranges, the heat resistance of the heat resistant layer may be enhanced.

### Thickness of Heat Resistant Layer

In an implementation, the thickness of the heat resistant layer may be, e.g., about 5 length % to about 45 length %, or about 10 length % to about 30 length % of the thickness of the substrate, based on the thickness of the heat resistant layer formed on one surface of the porous substrate.

In an implementation, the thickness of the heat resistant layer may be about 0.1 μm to about 5 μm, or about 0.1 μm to about 3 μm.

### Substrate

The substrate may be a porous substrate.

The porous substrate may be a polymer film formed of a polymer, or a copolymer or mixture of two or more of polyolefin such as polyethylene or polypropylene, a polyester such as polyethyleneterephthalate, or polybutyleneterephthalate, polyacetal, polyamide, polyimide, polycarbonate, polyether ketone, polyaryl ether ketone, polyether imide, polyamideimide, polybenzimidazole, polyether sulfone, polyphenyleneoxide, a cyclic olefin copolymer, polyphenylenesulfide, polyethylenenaphthalate, a glass fiber, TEFLON (tetrafluoroethylene), or polytetrafluoroethylene.

In an implementation, the porous substrate may be a polyolefin substrate containing polyolefin. In an implementation, the polyolefin substrate may have an excellent shutdown function, which may help contribute to improving the safety of the battery. The polyolefin substrate may include, e.g., a polyethylene single film, a polypropylene single film, a polyethylene/polypropylene double film, a polypropylene/polyethylene/polypropylene triple film, or a polyethylene/polypropylene/polyethylene triple film. In an implementation, the polyolefin resin may include a non-olefin resin in addition to an olefin resin, or may include a copolymer of olefin and non-olefin monomer.

The porous substrate may have a thickness of about 1 μm to about 40 μm, e.g., about 1 μm to about 30 μm, about 1 μm to about 20 μm, about 5 μm to about 20 μm, about 5 μm to about 15 μm, or about 5 μm to about 10 μm.

### Manufacturing Method

The separator for a rechargeable lithium battery according to some embodiments may be manufactured by various suitable methods. In an implementation, a separator for a rechargeable lithium battery may be formed by coating a composition for forming each layer to one or both surfaces of a porous substrate and then drying it.

The coating may be, e.g., spin coating, dip coating, bar coating, die coating, slit coating, roll coating, inkjet printing, or the like.

The drying may be, e.g., performed through natural drying, drying with warm air, hot air, or low humid air, vacuum-drying, or radiation of a far-infrared ray, an electron beam, or the like. The drying process may be performed at a temperature of, e.g., about 25° C. to about 120° C.

The separator for a rechargeable lithium battery may be manufactured by lamination, coextrusion, or the like in addition to the aforementioned method.

### Positive Electrode Active Material

The positive electrode active material may be a compound (lithiated intercalation compound) capable of intercalating and deintercalating lithium. In an implementation, one or more types of composite oxides of lithium and a metal, e.g., cobalt, manganese, nickel, or combinations thereof, may be used.

The composite oxide may be a lithium transition metal composite oxide, e.g., lithium nickel oxide, lithium cobalt oxide, lithium manganese oxide, a lithium iron phosphate compound, cobalt-free lithium nickel-manganese oxide, or a combination thereof.

In an implementation, a compound represented by any of the following chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}Co_{b}X_{c}O_{2-α}D′_{α} (0.90≤1.8, 0≤b≤0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A may be Ni, Co, Mn, or a combination thereof; X may be Al, Ni, Co, Mn, Cr, Fe, Mg, Sr, V, a rare earth element, or a combination thereof, D′ may be O, F, S, P, or a combination thereof; G may be Al, Cr, Mn, Fe, Mg, La, Ce, Sr, V, or a combination thereof, and L¹ may be Mn, Al, or a combination thereof.

The positive electrode active material may include, e.g., a lithium nickel oxide represented by Chemical Formula I, a lithium cobalt oxide represented by Chemical Formula II, a lithium iron phosphate compound represented by Chemical Formula III, a cobalt-free lithium nickel-manganese oxide represented by Chemical Formula IV, or a combination thereof.

Liₐ₁Niₓ₁M¹_{y1}M²_{z1}O_{2-b1}X_{b1} [Chemical Formula I]

In Chemical Formula I, 0.9≤a1≤1.8, 0.9≤x1≤1, 0≤y1≤0.1, 0≤z1≤0.1, 0.9≤x1+y1+z1≤1.1, and 0≤b1≤0.1, M¹ and M² may each independently be Al, B, Ba, Ca, Ce, Co, Cr, Cu, Fe, Mg, Mn, Mo, Nb, Si, Sn, Sr, Ti, V, W, or Zr, and X may be F, P, or S.

Liₐ₂Coₓ₂M³_{y2}O_{2-b2}X_{b2} [Chemical Formula II]

In Chemical Formula II, 0.9≤a2≤1.8, 0.7≤x2≤1, 0≤y2≤0.3, 0.9≤x2+y2≤1.1, and 0≤b2≤0.1, M³ may be Al, B, Ba, Ca, Ce, Cr, Cu, Fe, Mg, Mn, Mo, Ni, Se, Si, Sn, Sr, Ti, V, W, Y, Zn, or Zr, and X may be F, P, or S.

Liₐ₃Feₓ₃M⁴_{y3}PO_{4-b3}X_{b3} [Chemical Formula III]

In Chemical Formula III, 0.9≤a3≤1.8, 0.6≤x3≤1, 0≤y3≤0.4, and 0≤b3≤0.1, M⁴ may be Al, B, Ba, Ca, Ce, Co, Cr, Cu, Mg, Mn, Mo, Ni, Se, Si, Sn, Sr, Ti, V, W, Y, Zn, or Zr, and X may be F, P, or S.

Liₐ₄Niₓ₄Mn_{y4}M⁵_{z4}O_{2-b4}X_{b4} [Chemical Formula IV]

In Chemical Formula IV, 0.9≤a2≤1.8, 0.9≤x4<1, 0<y4≤0.1, 0≤z4≤0.1, 0.9≤x4+y4+z4≤1.1, and 0≤b4≤0.1, M⁵ may be Al, B, Ba, Ca, Ce, Cr, Fe, Mg, Mo, Nb, Si, Sn, Sr, Ti, V, W, or Zr, and X may be F, P, or S.

In an implementation, the positive electrode active material may be a high nickel positive electrode active material having a nickel content of greater than or equal to about 90 mol %, greater than or equal to about 91 mol %, or greater than or equal to about 94 mol %, and less than or equal to about 99 mol % based on 100 mol % of metals excluding lithium in the lithium transition metal composite oxide. The high nickel positive electrode active materials may achieve high capacity and may be applied to a high-capacity, high-density rechargeable lithium battery.

### Positive Electrode

The positive electrode for a rechargeable lithium battery may include a current collector and a positive electrode active material layer on the current collector. The positive electrode active material layer may include a positive electrode active material and may further include a binder or a conductive material.

In an implementation, the positive electrode may further include an additive that may function as a sacrificial positive electrode.

A content of the positive electrode active material may be about 90 wt % to about 99.5 wt %, and a content of the binder and the conductive material may be about 0.5 wt % to about 5 wt %, respectively based on a total weight of the positive electrode active material layer.

The binder may attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like.

The conductive material may impart conductivity (e.g., electrical conductivity) to the electrode. A suitable material that does not cause chemical change (e.g., does not cause an undesirable chemical change in the rechargeable lithium battery) and conducts electrons may be used in the battery. Examples of the conductive material may include a carbon material such as natural graphite, artificial graphite, carbon black, acetylene black, ketjen black, a carbon fiber, a carbon nanofiber, and carbon nanotube; a metal material including copper, nickel, aluminum, silver, etc., in a form of a metal powder or a metal fiber; a conductive polymer such as a polyphenylene derivative; or a mixture thereof.

The current collector may include Al.

### Negative Electrode Active Material

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon negative electrode active material, e.g., crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (wherein Q is an alkali metal, an alkaline-earth metal, a Group 13 element, a Group 14 element (excluding Si), a Group 15 element, a Group 16 element, a transition metal, a rare earth element, or a combination thereof). The Sn negative electrode active material may include Sn, SnO₂, a Sn alloy, or a combination thereof.

The negative electrode active material may be a silicon-carbon composite. In addition, the silicon-carbon composite may be a composite of silicon and amorphous carbon. In an implementation, the silicon-carbon composite may be in a form of silicon particles and amorphous carbon coated on the surface of the silicon particles. In an implementation, the silicon-carbon composite may include a secondary particle (core) in which primary silicon particles are assembled, and an amorphous carbon coating layer (shell) on the surface of the secondary particle. The amorphous carbon may also be between the primary silicon particles, and, e.g., the primary silicon particles may be coated with the amorphous carbon. The secondary particle may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on a surface of the core.

The Si negative electrode active material or Sn negative electrode active material may be used by mixing with a carbon negative electrode active material.

### Negative Electrode

A negative electrode for a rechargeable lithium battery may include a current collector and a negative electrode active material layer on the current collector. The negative electrode active material layer includes a negative electrode active material and may further include a binder or a conductive material.

In an implementation, the negative electrode active material layer may include about 90 wt % to about 99 wt % of the negative electrode active material, about 0.5 wt % to about 5 wt % of the binder, and about 0.5 wt % to about 5 wt % of the conductive material.

The binder may attach the negative electrode active material particles well to each other and may also attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

In an implementation, an aqueous binder may be used as the negative electrode binder, and it may further include a cellulose compound capable of imparting viscosity. The cellulose compound may include, e.g., carboxymethyl cellulose, hydroxypropylmethyl cellulose, methyl cellulose, or alkali metal salts thereof. The alkali metal may be Na, K, or Li.

The dry binder may be a polymer material capable of being fiberized, and may be, e.g., polytetrafluoroethylene, polyvinylidene fluoride, polyvinylidene fluoride-hexafluoropropylene copolymer, polyethylene oxide, or a combination thereof.

The conductive material may provide electrode conductivity, and a suitable electrically conductive material that does not cause a chemical change may be used. Examples of the conductive material may include a carbon material such as natural graphite, artificial graphite, carbon black, acetylene black, ketjen black, a carbon fiber, a carbon nanofiber, a carbon nanotube, and the like; a metal material such as copper, nickel, aluminum silver, and the like in a form of a metal powder or a metal fiber; a conductive polymer such as a polyphenylene derivative; or a mixture thereof.

The negative electrode current collector may include a copper foil, a nickel foil, a stainless steel foil, a titanium foil, a nickel foam, a copper foam, a polymer substrate coated with a conductive metal, or a combination thereof.

### Electrolyte Solution

The electrolyte solution for a rechargeable lithium battery may include, e.g., a non-aqueous organic solvent and a lithium salt.

The non-aqueous organic solvent may serve as a medium for transmitting ions taking part in the electrochemical reaction of a battery.

The non-aqueous organic solvent may include a carbonate, ester, ether, ketone, alcohol solvent, aprotic solvent, or a combination thereof.

The carbonate solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or the like. The ester solvent may include methyl acetate, ethyl acetate, n-propyl acetate, dimethylacetate, methylpropionate, ethylpropionate, decanolide, mevalonolactone, valerolactone(valerolactone), caprolactone, or the like. The ether solvent may include dibutyl ether, tetraglyme, diglyme, dimethoxyethane, 2-methyltetrahydrofuran, 2,5-dimethyltetrahydrofuran, or tetrahydrofuran. The ketone solvent may include cyclohexanone. The alcohol solvent may include ethyl alcohol, isopropyl alcohol, and the like. The aprotic solvent may include nitriles such as R—CN (wherein R is a C2 to C20 linear, branched, or cyclic hydrocarbon group, a double bond, an aromatic ring, or an ether group), amides such as dimethylformamide, dioxolanes such as 1,3-dioxolane or 1,4-dioxolane, sulfolanes, or the like.

The non-aqueous organic solvent may be used alone or in combination of two or more.

In an implementation, a carbonate solvent may be used, a cyclic carbonate and chain carbonate can be mixed and used, and the cyclic carbonate and chain carbonate may be mixed at a volume ratio of about 1:1 to about 1:9.

The lithium salt dissolved in the organic solvent may supply lithium ions in a battery, may enable a basic operation of a rechargeable lithium battery, and may help improve transportation of the lithium ions between positive and negative electrodes. Examples of the lithium salt may include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), wherein x and y are integers from 1 to 20, lithium trifluoromethane sulfonate, lithium tetrafluoroethanesulfonate, lithium difluorobis(oxalato)phosphate (LiDFOB), and lithium bis(oxalato)borate (LiBOB).

### Rechargeable Lithium Battery

The rechargeable lithium battery may be classified into cylindrical, prismatic, pouch, or coin-type batteries, and the like depending on its shape. The FIGURE is a schematic sectional view showing a rechargeable lithium battery according to some embodiments, which may be in a form of a prismatic battery. Referring to the FIGURE, the rechargeable lithium battery 100 may include an electrode assembly 40 including a separator 30 between a positive electrode 10 and a negative electrode 20, and a case 50 in which the electrode assembly 40 is housed. The positive electrode 10, the negative electrode 20, and the separator 30 may be impregnated with an electrolyte solution (not shown). Additionally, the rechargeable lithium battery 100 may include a positive electrode lead tab 11, a positive electrode terminal 12, a negative lead tab 21, and a negative electrode terminal 22.

The rechargeable lithium battery according to some embodiments may be applied to automobiles, mobile phones, or various types of electrical devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Preparation Examples and Comparative Preparation Examples

### Preparation Example 1: Preparation of Composition for Forming Heat Resistant Adhesive Layer

### (1) Preparation of Swellable Adhesive Binder

A swellable adhesive binder with a core-shell structure having a D50 particle size of 0.5 μm, a glass transition temperature of 65° C., a swelling degree of 8 times was prepared.

In the swellable adhesive binder, a core included a copolymer of alkylacrylate and divinylbenzene, and a shell included a copolymer of 70 wt % of styrene, 20 wt % of 2-ethylhexylmethacrylate, and 10 wt % of acrylphsophonate.

In addition, the swelling degree of the swellable adhesive binder refers to a swelling degree after being allowed to stand in an electrolyte solution at 60° C. for 72 hours relative to an initial volume, and the electrolyte solution is a mixed solution of ethyl carbonate (EC)/ethylmethyl carbonate (EMC)/diethyl carbonate (DEC) (in a volume ratio of 3/5/2) including LiPF₆ at a concentration of 1.3 M. Hereinafter, the definition of the swelling degree of the swellable adhesive binder is the same as above.

### (2) Preparation of Composition for Forming Heat Resistant Adhesive Layer

As the first inorganic particles, boehmite with a D50 particle size of 0.3 μm was used. A composition for forming a heat resistant adhesive layer was prepared in water as a solvent, with a weight ratio of swellable adhesive binder:first inorganic particles of 1:8.

### Preparation Example 2: Preparation of Composition for Forming Heat Resistant Adhesive Layer

A composition for forming a heat resistant adhesive layer was prepared in the same manner as Preparation Example 1, except that the weight ratio of the swellable adhesive binder:the first inorganic particle was 1:9.

### Preparation Example 3: Preparation of Composition for Forming Heat Resistant Adhesive Layer

A composition for forming a heat resistant adhesive layer was prepared in the same manner as Preparation Example 1, except that the weight ratio of the swellable adhesive binder:the first inorganic particle was 1:10.

### Preparation Example 4: Preparation of Composition for Forming Heat Resistant Adhesive Layer

A composition for forming a heat resistant adhesive layer was prepared in the same manner as Preparation Example 1, except that the weight ratio of the swellable adhesive binder:the first inorganic particle was 1:11.

### Preparation Example 5: Preparation of Composition for Forming Heat Resistant Layer

### (1) Preparation of Heat Resistant Binder

The first heat resistant binder, the second heat resistant binder, or a combination thereof may be used as a heat resistant binder, but herein, the second heat resistant binder was used.

A method of manufacturing the second heat resistant binder was as follows.

In a 10 L four-necked flask equipped with a stirrer, a thermometer, and a cooling tube, after adding distilled water (6,361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and 5 N lithium hydroxide aqueous solution (1.05 equivalents based on a total amount of 2-acrylamido-2-methylpropanesulfonic acid), the operation of reducing an internal pressure to 10 mmHg with diaphragm pump and returning the internal pressure to normal pressure with nitrogen, was performed three times.

While controlling the temperature of reaction solution so as to be stable between 65° C. to 70° C., the reaction was conducted for 12 hours. After cooling to ambient temperature, the pH of the reaction solution was adjusted to 7 to 8 using a 25% aqueous ammonia solution.

The poly(acrylic acid-co-acrylamide-co-lithium 2-acrylamido-2-methylpropanesulfonate salt) was prepared in this manner. Herein, the molar ratio of the structural unit of acrylic acid, the structural unit of acrylamide, and the structural unit of 2-acrylamido-2-methylpropanesulfonic acid was 10:85:5. About 10 mL of the reaction solution (reaction product) was taken and the measurement result of the non-volatile component was 9.5% (theoretical value: 10%).

### (2) Preparation of Composition for Forming Heat Resistant Layer

As the second inorganic particles, boehmite with a D50 particle size of 0.3 μm was used. A composition for forming a heat resistant layer was prepared in water as a solvent, with a weight ratio of heat resistant binder:second inorganic particles of 1:30.

### Comparative Preparation Example 1

A swellable adhesive binder with a core-shell structure having a D50 particle size of 0.5 μm, a glass transition temperature of 65° C., and a swelling degree of three times was prepared. In the swellable adhesive binder, a core included a copolymer of alkylacrylate and divinylbenzene, and a shell included a copolymer of 70 wt % of styrene, 20 wt % of 2-ethylhexylmethacrylate, and 10 wt % of acrylonitrile.

A composition for forming a heat resistant adhesive layer was prepared in the same manner as Preparation Example 2, except that the swellable adhesive binder was used.

### Comparative Preparation Example 2

A swellable adhesive binder with a core-shell structure having a D50 particle size of 0.5 μm, a glass transition temperature of 100° C., and a swelling degree of 5 times was prepared. In the swellable adhesive binder, a core included a copolymer of alkylacrylate and divinylbenzene, and a shell included a copolymer of 70 wt % of styrene, 20 wt % of butyl acrylate, and 10 wt % of acrylonitrile.

A composition for a heat resistant adhesive layer was prepared in the same manner as in Preparation Example 2 except that the swellable adhesive binder was used.

### Examples and Comparative Examples

### Example 1

### (1) Manufacturing of Separator

Heat-resistant adhesive layers with different compositions were formed on both surfaces of the substrate.

(Negative electrode side) The heat resistant adhesive layer (a thickness: 2.0 μm) was formed on one surface of an 9.0 μm-thick polyethylene film (PE, SK Innovation Co., Ltd.) as a substrate by coating the composition for forming a heat resistant adhesive layer according to Preparation Example 1 at 20 m/min in a direct metering method and drying it at 60° C. under an absolute vapor amount (average value) of 14 g/m³. The loading amount of the swellable adhesive binder in the heat resistant adhesive layer is shown in Table 2. Herein, the loading amount of the swellable adhesive binder may be a value calculated by calculating the weight of the swellable adhesive binder included per unit area of the heat resistant adhesive layer.

(Positive electrode side) A heat resistant layer (thickness: 2.0 μm) was formed on the other surface of the substrate using the same method as above, except that the composition for forming a heat resistant layer of Preparation Example 5 was used.

### (2) Manufacture of Rechargeable Lithium Battery Cell

Positive electrode slurry was prepared by mixing LiNi_{0.91}Co_{0.05}Al_{0.04}O₂ as a positive electrode active material, polyvinylidene fluoride (PVDF) as a binder, and carbon as a conductive agent in a weight ratio of 92:4:4 and dispersing the mixture in N-methyl-2-pyrrolidone. This slurry was coated to be 20 μm thick on an aluminum foil, dried, and pressed to manufacture a positive electrode.

Artificial graphite as a negative electrode active material, a styrene-butadiene rubber as a binder, and carboxymethyl cellulose as a thickener in a weight ratio of 96:2:2 were dispersed in distilled water to prepare negative electrode active material slurry. The slurry was coated on a 15 μm-thick, dried, and compressed to manufacture a negative electrode.

The separator was sandwiched between the positive electrode and the negative electrode to manufacture a stack, and the side on which the heat resistant adhesive layer was formed was attached to the negative electrode, and the side on which the heat resistant layer was formed was attached to the positive electrode. The stack was wound to make a jelly-roll, the jelly-roll was placed in a prismatic case, and electrolyte solution was injected to manufacture a prismatic battery cell.

The electrolyte solution was prepared by mixing ethyl carbonate (EC)/ethylmethyl carbonate (EMC)/diethyl carbonate (DEC) (in a volume ratio of 3/5/2) and dissolving LiPF₆ therein at a concentration of 1.3 M.

### Example 2

A separator and a rechargeable lithium battery cell were manufactured in the same manner as in Example 1 except that the negative electrode side of the separator was formed by using the composition for forming a heat resistant adhesive layer according to Preparation Example 2.

### Example 3

A separator and a rechargeable lithium battery cell were manufactured in the same manner as in Example 1 except that the negative electrode side of the separator was formed by using the composition for forming a heat resistant adhesive layer according to Preparation Example 3.

### Example 4

A separator and a rechargeable lithium battery cell were manufactured in the same manner as in Example 1 except that the negative electrode side of the separator was formed by using the composition for forming a heat resistant adhesive layer according to Preparation Example 4.

### Comparative Example 1

A separator and a rechargeable lithium battery were manufactured in the same manner as in Example 1, except that the composition for forming a heat resistant adhesive layer of Comparative Preparation Example 1 was used when forming the negative electrode side of the separator.

### Comparative Example 2

A separator and a rechargeable lithium battery were manufactured in the same manner as in Example 1, except that the composition for forming a heat resistant adhesive layer of Comparative Preparation Example 2 was used when forming the negative electrode side of the separator.

Each of the separators of the Examples and the Comparative Examples is summarized in Tables 1 and 2.

TABLE 1

| | Heat resistant adhesive layer | | | | |
|---|---|---|---|---|---|
| | First inorganic | | | | |
| | particles | Swellable adhesive | Swellable adhesive binder | | |
| | D50 particle | binder:first | | Loading amount | Thickness |
| | diameter (μm) | inorganic particles | Composition of shell | (g/m²) | (μm) |
| Ex. 1 | 0.3 | 1:8 | SM-EHMA- | 0.30 | 2.0 |
| | | | phosphorus acryl | | |
| Ex. 2 | 0.3 | 1:9 | SM-EHMA- | 0.27 | 2.0 |
| | | | phosphorus acryl | | |
| Ex. 3 | 0.3 | 1:10 | SM-EHMA- | 0.25 | 2.0 |
| | | | phosphorus acryl | | |
| Ex. 4 | 0.3 | 1:11 | SM-EHMA- | 0.23 | 2.0 |
| | | | phosphorus acryl | | |
| Comp. Ex. 1 | 0.3 | 1:9 | SM-EHMA-AN | 0.27 | 2.0 |
| Comp. Ex. 2 | 0.3 | 1:9 | SM-BA-AN | 0.27 | 2.0 |

TABLE 2

| | | Heat resistant layer | | |
|---|---|---|---|---|
| | | | Second inorganic | |
| | Substrate | | particles | |
| | Thickness | Heat resistant binder | D50 particle | Thickness |
| | (μm) | Type | diameter (μm) | (μm) |
| Ex. 1 | 9.0 | second heat resistant | 0.3 | 2.0 |
| | | binder | | |
| Ex. 2 | 9.0 | second heat resistant | 0.3 | 2.0 |
| | | binder | | |
| Ex. 3 | 9.0 | second heat resistant | 0.3 | 2.0 |
| | | binder | | |
| Ex. 4 | 9.0 | second heat resistant | 0.3 | 2.0 |
| | | binder | | |
| Comp. | 9.0 | second heat resistant | 0.3 | 2.0 |
| Ex. 1 | | binder | | |
| Comp. | 9.0 | second heat resistant | 0.3 | 2.0 |
| Ex. 2 | | binder | | |

### Evaluation Examples

The evaluation results for each separator of the Examples and Comparative Examples are listed in Table 3.

### Evaluation Example 1: Resistance of Separator

Each of the separators of the Examples and Comparative Examples was manufactured and then, immediately manufactured into a 2032 coin cell, which was measured with respect to AC impedance, and the results are shown in Table 3.

### Evaluation Example 2: Dry Shrinkage Rate of Separator

Each of the separators of the Examples and Comparative Examples was cut into a size of 10 cm×10 cm to prepare a sample, which was allowed to stand at 150° C. in a convection oven for 1 hour and taken out therefrom to measure each length variation ratio in a machine direction (MD) and a transverse direction (TD), and the results are shown in Table 3.

### Evaluation Example 3: Evaluation of Wet Adhesive Strength of Separator

### (Peeling Test)

### (1) Adhesive Strength Between Separator and Positive Electrode

Each of the rechargeable lithium battery cells of the Examples and Comparative Examples was maintained at 40° C. under a load of 50 kg for 2 hours. After separating a separator thereof from a positive electrode by about 15 mm electrode and fixing the positive electrode to a lower grip, while fixing the separator to an upper grip, they were peeled in a direction of 180° at 100 mm/min. Subsequently, a force required to peel them by 40 mm was measured three times and averaged to obtain an arithmetic average value, and the results are shown in Table 3.

### (2) Adhesive Strength Between Separator and Negative Electrode

The peeling test was equally performed for the separator and the negative electrode, and the results are shown in Table 3.

Evaluation Example 4: High-temperature Cycle-life and High-temperature Storage Characteristics of Rechargeable Lithium Battery Cell

### (1) High-Temperature Cycle-Life Characteristics

Each of the rechargeable lithium battery cells of the Examples and Comparative Examples was charged to an upper limit voltage of 4.25 V at a constant current of 0.1 C and discharged to a cut-off voltage of 3.5 V at a constant current of 0.1 C at 55° C. for initial charge and discharge. Subsequently, the cells were charged and discharged 10 times at 0.5 C within a voltage range of 3.5 V to 4.25 V.

After the 10 cycles, the rechargeable lithium battery cells were measured with respect to a battery temperature, which was used to calculate a degree that a temperature increased from its initial temperature, and the results are shown in Table 4. In addition, efficiency was calculated according to Equation 1, and the results are shown in Table 4.

$$Efficiency = ( Discharge capacity after 10 cycles / Discharge capacity after 1 cycle ) * 100 \qquad [ Equation 1 ]$$

### (2) High-Temperature Storage Characteristics

Each rechargeable lithium battery cell of the above Examples and Comparative Examples was charged and discharged once at 0.33 C to measure charge and discharge capacity (before high temperature storage).

In addition, each rechargeable lithium battery cell of the above Examples and Comparative Examples was charged to SOC100% (charged to reach 100% charge capacity when the total charge capacity of the battery was set to 100%), and stored at 60° C. for 60 days, and then the discharge capacity was measured by discharging under constant current conditions up to 3.0 V at 0.33 C.

The efficiency was calculated according to Equation 2 and shown in Table 4.

$$Efficiency = ( discharge capacity after high temperature storage / discharge capacity before high temperature storage ) * 100 \qquad [ Equation 2 ]$$

Meanwhile, for each rechargeable lithium battery cell of the above Examples and Comparative Examples, the initial direct current resistance (DC-IR) was measured using ΔV/ΔI (change in voltage/change in current) values, then the maximum energy state inside the battery was set to a fully charged state (SOC 100%), in this state, the cell was stored at high temperature (60° C.) for 60 days, the direct current resistance was measured, the DC-IR increase rate (%) was calculated according to Equation 3, and the results are shown in Table 4.

$$DC - IR increase rate = \{ ( DC - IR after high temperature storage ) / ( DC \text{} - IR before high temperature storage ) \} * 100 \qquad [ Equation 3 ]$$

TABLE 3

| | Separator | | | | |
|---|---|---|---|---|---|
| | | | | Wet adhesive | |
| | | | | strength (gf/mm) | |
| | | Dry shrinkage | | separator- | separator- |
| | Resistance | rate (%) | | positive | negative |
| | (Ω) | MD | TD | electrode | electrode |
| Ex. 1 | 0.57 | 2.0 | 2.0 | 0.02 | 0.15 |
| Ex. 2 | 0.54 | 2.0 | 2.0 | 0.02 | 0.13 |
| Ex. 3 | 0.51 | 1.7 | 1.5 | 0.02 | 0.05 |
| Ex. 4 | 0.50 | 1.5 | 1.5 | 0.02 | 0.05 |
| Comp. Ex. 1 | 0.52 | 2.2 | 1.6 | 0.02 | 0.03 |
| Comp. Ex. 2 | 0.51 | 2.5 | 2.0 | 0.02 | 0.03 |

TABLE 4

| | Rechargeable lithium battery cell | | | |
|---|---|---|---|---|
| | High-temperature cycle-life | | High-temperature storage | |
| | (55° C., 10 cyc.) | | (60° C., 60 Day) | |
| | temperature | efficiency | efficiency | DC-IR increase |
| | change (° C.) | (%) | (%) | rate (%) |
| Ex. 1 | 4.7 | 98 | 89 | 168 |
| Ex. 2 | 6.1 | 99 | 88 | 168 |
| Ex. 3 | 6.7 | 95 | 90 | 168 |
| Ex. 4 | 7.2 | 93 | 86 | 165 |
| Comp. Ex. 1 | 11.0 | 87 | 88 | 168 |
| Comp. Ex. 2 | 13.0 | 85 | 87 | 169 |

### Summary

In Examples 1 to 4, compared to Comparative Examples 1 and 2, the wet adhesive strength between the separator and the negative electrode was improved after going through the process under low-temperature and low-pressure conditions, and the high temperature charge and discharge (cycle-life) characteristics of the rechargeable lithium battery cells were improved.

The separators of Examples 1 to 4 suppressed the increase in resistance, but had a dry shrinkage rate (both MD/TD) of less than 5% at 150° C., after going through a process under low-temperature and low-pressure conditions, the wet adhesion between the separator and the negative electrode was greater than or equal to 0.05 gf/mm.

In addition, the rechargeable lithium battery cells of Examples 1 to 4 ensured high-temperature storage characteristics, had a temperature change of less than 10° C. during high-temperature charging and discharging (cycle-life), and had an efficiency of greater than or equal to 90%.

By way of summation and review, in order to help prevent short circuits between the positive and negative electrodes of rechargeable lithium batteries, olefin substrates may be used as separators. The olefin substrate may have excellent flexibility, but may have rapid heat shrinkage at high temperatures.

As the capacity or output of a rechargeable lithium battery increases, an amount of heat generated during charging and discharging may also increase, and heat resistance of the separator may need to be increased. A rechargeable lithium battery may be stored or charged and discharged at high temperature, and an adhesive strength between the separator and the negative electrode could weaken, compared to the adhesive strength between the separator and the positive electrode, and the adhesive strength between the separator and the negative electrode may need to be strengthened.

One or more embodiments may provide a rechargeable lithium battery with improved high-temperature charging/discharging or storage characteristics even when the capacity or output are increased.

One or more embodiments may provide a high-capacity or high-output rechargeable lithium battery with improved high-temperature charge/discharge or storage characteristics as a result of applying a separator with excellent heat resistance on both surfaces and enhanced adhesive strength on one surface.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable lithium battery, comprising:
a positive electrode including a positive electrode active material having a nickel content among a transition metal of greater than or equal to about 90 mol %;
a negative electrode; and
a separator between the positive electrode and the negative electrode,
wherein:
the separator includes:
a substrate;
a heat resistant adhesive layer on one surface of the substrate; and
a heat resistant layer on another surface of the substrate,
the heat resistant adhesive layer includes:
first inorganic particles; and
a swellable adhesive binder,
the swellable adhesive binder includes:
a first structural unit of a vinyl aromatic monomer;
a second structural unit of an alkyl acrylate monomer; and
a third structural unit of a phosphonate monomer,
the heat resistant layer includes:
second inorganic particles; and
a heat resistant binder.

2. The rechargeable lithium battery as claimed in claim 1, wherein:
in the swellable adhesive binder,
the first structural unit of the vinyl aromatic monomer is represented by Chemical Formula 1,
the second structural unit of the alkyl acrylate monomer is represented by Chemical Formula 2, and
the third structural unit of the phosphonate monomer is represented by Chemical Formula 3: 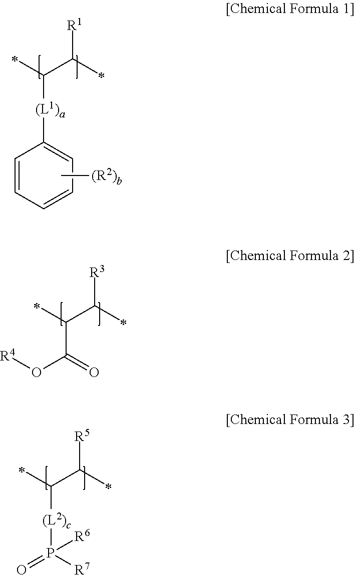
in Chemical Formulae 1 to 3,
R¹, R³, and R⁵ are each independently hydrogen or a substituted or unsubstituted C1 to C6 alkyl group;
R² is fluorine, a substituted or unsubstituted C1 to C6 alkyl group, a substituted or unsubstituted C6 to C20 aryl group, or a substituted or unsubstituted C1 to C6 alkenyl group,
R⁴ is a substituted or unsubstituted C1 to C20 alkyl group,
L¹ is a substituted or unsubstituted C1 to C6 alkylene group, a substituted or unsubstituted C3 to C10 cycloalkylene group, a substituted or unsubstituted C6 to C20 arylene group, or a combination thereof,
L² is a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof,
R⁶ and R⁷ are each independently a substituted or unsubstituted C1 to C10 alkoxy group, or a substituted or unsubstituted C6 to C20 aryloxy group,
a and c are each independently an integer of 0 to 2, and
b is an integer of 0 to 5.

3. The rechargeable lithium battery as claimed in claim 1, wherein:
the swellable adhesive binder is a particle with a core-shell structure, and
the shell includes the first structural unit of a vinyl aromatic monomer; the second structural unit of an alkyl acrylate monomer; and the third structural unit of a phosphonate monomer.

4. The rechargeable lithium battery as claimed in claim 1, wherein the first inorganic particles include Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

5. The rechargeable lithium battery as claimed in claim 1, wherein a weight ratio of the swellable adhesive binder and the first inorganic particles in the heat resistant adhesive layer is about 1:3 to about 1:20.

6. The rechargeable lithium battery as claimed in claim 1, wherein the heat resistant adhesive layer has a thickness of about 0.1 μm to about 5 μm.

7. The rechargeable lithium battery as claimed in claim 1, wherein:
the heat resistant binder includes a first heat resistant binder, a second heat resistant binder, or a combination thereof,
the first heat resistant binder includes:
a fourth structural unit of a (meth)acrylic acid monomer or a (meth)acrylate monomer;
a cyano group-containing fifth structural unit; and
a sulfonate group-containing sixth structural unit, and
the second heat resistant binder includes:
a seventh structural unit including a structural unit of a (meth)acrylic acid monomer or a (meth)acrylate monomer and a structural unit of a (meth)acrylamide monomer; and
an eighth structural unit of a (meth)acrylamidosulfonic acid monomer or a salt thereof.

8. The rechargeable lithium battery as claimed in claim 7, wherein:
the fourth structural unit of a (meth)acrylic acid monomer or a (meth)acrylate monomer is represented by of Chemical Formula 11, Chemical Formula 12, Chemical Formula 13, of a combination thereof,
the cyano group-containing fifth structural unit is represented by Chemical Formula 14, and
the sulfonate group-containing sixth structural unit is represented by Chemical Formula 15, Chemical Formula 16, Chemical Formula 17, or a combination thereof: 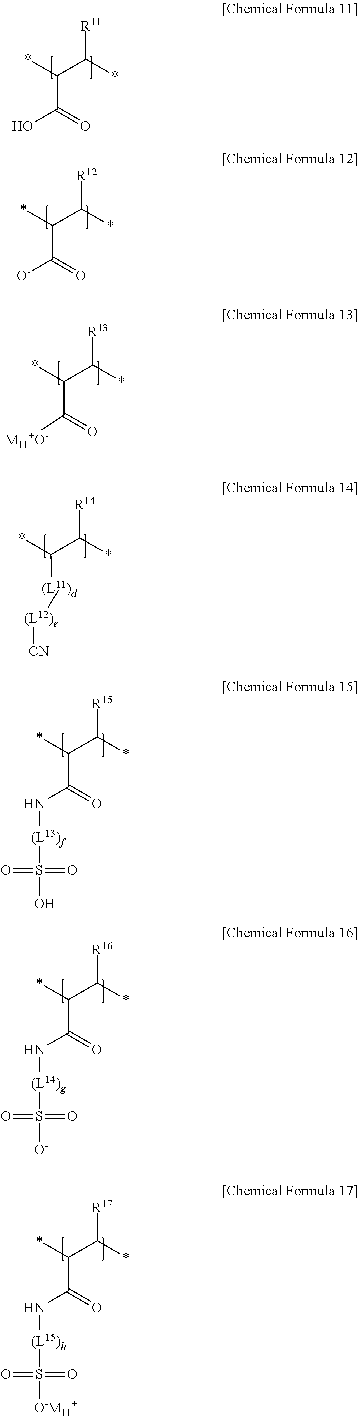
in Chemical Formulae 11 to 17,
R¹¹ to R¹⁷ are each independently hydrogen or a substituted or unsubstituted C1 to C6 alkyl group;
L¹¹ and L¹² are each independently a single bond, a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
L¹³ to L¹⁵ are each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁₁ is an alkali metal; and
d, e, f, g, and h are each independently an integer of 0 to 2.

9. The rechargeable lithium battery as claimed in claim 7, wherein:
the seventh structural unit including the structural unit of a (meth)acrylic acid monomer or a (meth)acrylate monomer is represented by Chemical Formula 101, Chemical Formula 102, Chemical Formula 103, or a combination thereof,
the seventh structural unit including the structural unit of a (meth)acrylamide monomer is represented by Chemical Formula 104, and
the eighth structural unit of a (meth)acrylamidosulfonic acid monomer or a salt thereof is represented by Chemical Formula 105, Chemical Formula 106, Chemical Formula 107, or a combination thereof: 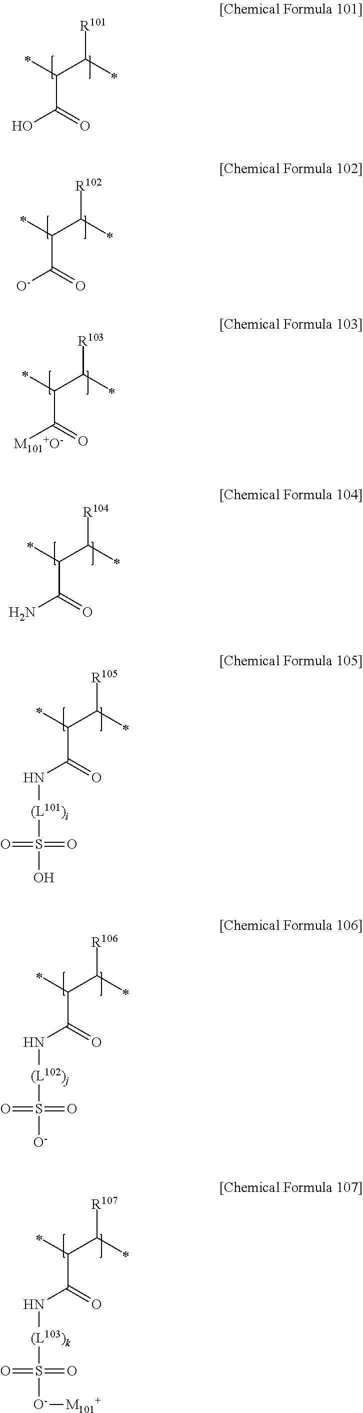
in Chemical Formulae 101 to 107,
R¹⁰¹ to R¹⁰⁷ are each independently hydrogen or a substituted or unsubstituted C1 to C6 alkyl group;
L¹⁰¹ to L¹⁰³ are each independently a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group;
M₁₀₁ is an alkali metal; and
i, j, and k are each independently an integer of 0 to 2.

10. The rechargeable lithium battery as claimed in claim 1, wherein the second inorganic particles include Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

11. The rechargeable lithium battery as claimed in claim 1, wherein a weight ratio of the heat resistant binder and the second inorganic particles in the heat resistant layer is about 1:2 to about 1:50.

12. The rechargeable lithium battery as claimed in claim 1, wherein the heat resistant layer has a thickness of about 0.1 μm to about 5 μm.

13. The rechargeable lithium battery as claimed in claim 1, wherein the substrate is a polyolefin substrate.

14. The rechargeable lithium battery as claimed in claim 1, wherein the substrate has a thickness of about 1 μm to about 40 μm.

15. The rechargeable lithium battery as claimed in claim 1, wherein:
the heat resistant adhesive layer is attached to the negative electrode, and
the heat resistant layer is attached to the positive electrode.

16. The rechargeable lithium battery as claimed in claim 1, wherein:
the positive electrode includes a positive electrode active material represented by Chemical Formula I:
Liₐ₁Niₓ₁M¹_{y1}M²_{z1}O_{2-b1}X_{b1} [Chemical Formula I]
in Chemical Formula I,
0.9≤a1≤1.8, 0.9≤x1≤1, 0≤y1≤0.1, 0≤z1≤0.1, 0.9≤x1+y1+z1≤1.1, and 0≤b1≤0.1,
M¹ and M² are each independently Al, B, Ba, Ca, Ce, Co, Cr, Cu, Fe, Mg, Mn, Mo, Nb, Si, Sn, Sr, Ti, V, W, or Zr, and
X is F, P, or S.

17. The rechargeable lithium battery as claimed in claim 1, wherein the negative electrode includes negative electrode active material including a carbon negative electrode active material, a Si negative electrode active material, or a combination thereof.

18. The rechargeable lithium battery as claimed in claim 1, further comprising an electrolyte solution impregnated in the separator.

19. The rechargeable lithium battery as claimed in claim 18, wherein the electrolyte solution includes a lithium salt and a non-aqueous organic solvent.

20. The rechargeable lithium battery as claimed in claim 1, wherein the rechargeable lithium battery has an energy density of greater than or equal to about 700 Wh/L.
